(19) United States
(12) Patent Application Publication
(10) Pub. No.: US 2013/0030907 A1
(43) Pub. Date: Jan. 31, 2013

(54) CLUSTERING OFFERS FOR CLICK-RATE OPTIMIZATION

(71) Applicant: Clifford Lyon, Melrose, MA (US)

(72) Inventor: Clifford Lyon, Melrose, MA (US)

(73) Assignee: CBS Interactive, Inc.

(21) Appl. No.: 13/193,417

(22) Filed: Jul. 28, 2011

(51) Int. Cl. G06Q 30/00

(52) U.S. Cl. 705/14.42

(57) ABSTRACT

A computerized method is provided for receiving data for a plurality of offers, wherein the data includes a number of impressions and a number of clicks associated with each offer in the plurality of offers. The method comprises determining a click-through rate for each offer in the plurality of offers using the received data for the plurality of offers and partitioning offers into a first offer group and a second offer group based on a value of performance data associated with each offer. A predetermined number of offers with highest values are assigned to the first offer group, and the rest of the offers are assigned to the second offer group. The method comprises serving offers from both groups, calculating a response rate and confidence level for the first group, calculating a response rate and confidence level for the second group and determining that the performance data of the first and second groups has diverged by a predetermined threshold. The method further comprises serving the offers based at least in part on the determining.

### BACKGROUND

Internet web pages display a wide variety of content to web page visitors including advertisements, news articles, search results, product reviews, and user-generated content. Web page visitors are more likely to return to a web page that consistently displays relevant and current content. Accordingly, operators of Internet web pages are faced with the challenge of selecting content to display and promote from a multitude of available content onto space-constrained web pages. In addition, Internet web page operators seek to improve the click-through rate of promoted content presented to the web page visitors. For example, a news article may be followed by a list of links to other articles on the same subject in an effort to increase time spent and pages turned, and to provide the user with a more satisfying experience. Finding the links that improve the overall click-through rate is a way to quantitatively make progress toward these efforts.

### BRIEF DESCRIPTION OF THE DRAWINGS

FIG. 1 is a chart of a simulation showing response rates and confidence intervals of 20,000 displays of 100 offers, according to an exemplary embodiment.

FIG. 2 is a chart of the simulation showing offers partitioned into two clusters and their response rates over time expressed in number of impressions, according to an exemplary embodiment.

FIG. 3 is a flowchart of a method, according to an exemplary embodiment.

FIG. 4 is a block diagram of a content management system and environment, according to an exemplary embodiment.

FIG. 5 is a block diagram of a computer system, according to an exemplary embodiment.

FIG. 6 is a block diagram of a user interface, according to an exemplary embodiment.

FIG. 7 is an image of a web page, according to an exemplary embodiment.

FIG. 8 is an image of a web page, according to an exemplary embodiment.

FIG. 9 is a chart of offers and performance data for the offers, illustrating an exemplary partitioning into “Top N” offers and “Rest” offers, according to an exemplary embodiment.

### DETAILED DESCRIPTION OF EXEMPLARY EMBODIMENTS

One approach for maximizing click-through rate on content links displayed on a web page is through use of schemes developed for the multi-armed bandit problem. In this problem a gambler seeks to maximize the sum of the rewards given by a number of one-armed bandits, or slot machines. The payoff probabilities of the slot machines are initially unknown, and are not assumed to be equal. Thus, the gambler spends some portion of his bank exploring the payoff probabilities by playing all of the machines, and once the machine with the highest payoff probability is established with some level of certainty, the remainder of the bank may be allocated to that machine. Of course, the sooner the gambler establishes the machine with the highest payoff probability, the higher the reward. But the earlier the gambler chooses a machine as best, the larger the possibility of error. Finding the right balance between exploring and exploiting in order to maximize reward (or minimize regret) is the basic tension of reinforcement learning.

In our scenario, the gambler is the content publisher. The selection of a link for display on a web page is likened to the pull of the arm of a single slot machine among the many possible links at our disposal, stored in memory. The reward is a click on a link by the user at a client device. If the payoff click-through rates for the links are unknown, the content publisher can explore by selecting a link at random and recording the response from the user at the client device. Once the content publisher has observed the click-through rates over a large number of trials, the content publisher can exploit the information gained by selecting the links with the highest payoff probability for display on subsequent web pages.

Several strategies exist for solving the multi-armed bandit problem, such as semi-uniform strategies, probability matching strategies and pricing strategies. The semi-uniform strategies include the epsilon-greedy strategy, epsilon-first strategy, epsilon-decreasing strategy and adaptive epsilon-greedy strategy based on value differences. However, the application of the problem to online publishing presents several confounding factors not found in the typical problem definition: the payoffs may not be stationary; data rates may be low, and the arms themselves are subject to churn, i.e. new links may be created and old ones removed on an irregular timetable as content becomes outdated and replaced with newer online content. In addition, the data latency—the “turn-around” time for tracking information—may be too great to keep up with that churn.

According to some embodiments, one or more of these confounding factors may be mitigated by using cumulative information in order to be able to maximize sooner.

For a set of offers, A={O₁, O₂, O₃, . . . Oₙ} with unknown click-rates, and a set of slots S on a page in which to display the offers, where |S|>=1, a processing circuit is configured to use offer displays to gain an estimate of click-through rate probability for each of the offers. Once the processing circuit determines which offers have the highest likelihood of response, the processing circuit can display the S best offers to maximize the click-rate.

The processing circuit may be configured to make a determination as to when to stop exploring. The determination may be made based on a determination of whether the best S offers are in fact the best, i.e., that more information would not change the view of the distribution of click-rates at any point. One method which may be implemented to make this determination is by modeling each “lever pull” or offer display as a Bernoulli trial. A Bernoulli trial is an experiment with two possible outcomes, for example, a coin flip. Here, the outcome of a link or offer display is a click (or other interaction), or no click (or other interaction). The click-through rate is the average historical probability of a click, and in one example, is also an estimator of future click probability. The processing circuit may be configured to determine how certain the estimate is by calculating a confidence interval for a Binomial proportion.

Because the size of online data is large, the normal approximation for the Binomial distribution can be used by the processing circuit. Given a click-through rate p, the formula for the confidence interval is:

$$p \pm {\text{?}}_{1 - n / \text{?}} \sqrt{\frac{μ ( 1 - p )}{\text{?}}}$$

$$\text{?} \text{indicates text missing or illegible when filed}$$

where n is the number of trials and [symbol] -n/2 is the 1−α/2 percentile of the normal distribution, e.g., about 1.96 for a 95% confidence interval. For example, given an offer with 6 clicks and 1,000 impressions the click-through rate is 0.6%, and the confidence interval is

$$0.0006 \pm 1.0 \text{?} \sqrt{\frac{\text{?}}{\text{?}}} , \\ \text{?} \text{indicates text missing or illegible when filed}$$

or the range 0.0034 to 0.0086. Through these assumptions, the processing circuit can now estimate that 95% of the time, the future click-through rate will fall in this range. The processing circuit can be configured to apply this operation to all the offers in our offer pool after it has displayed them on a web page.

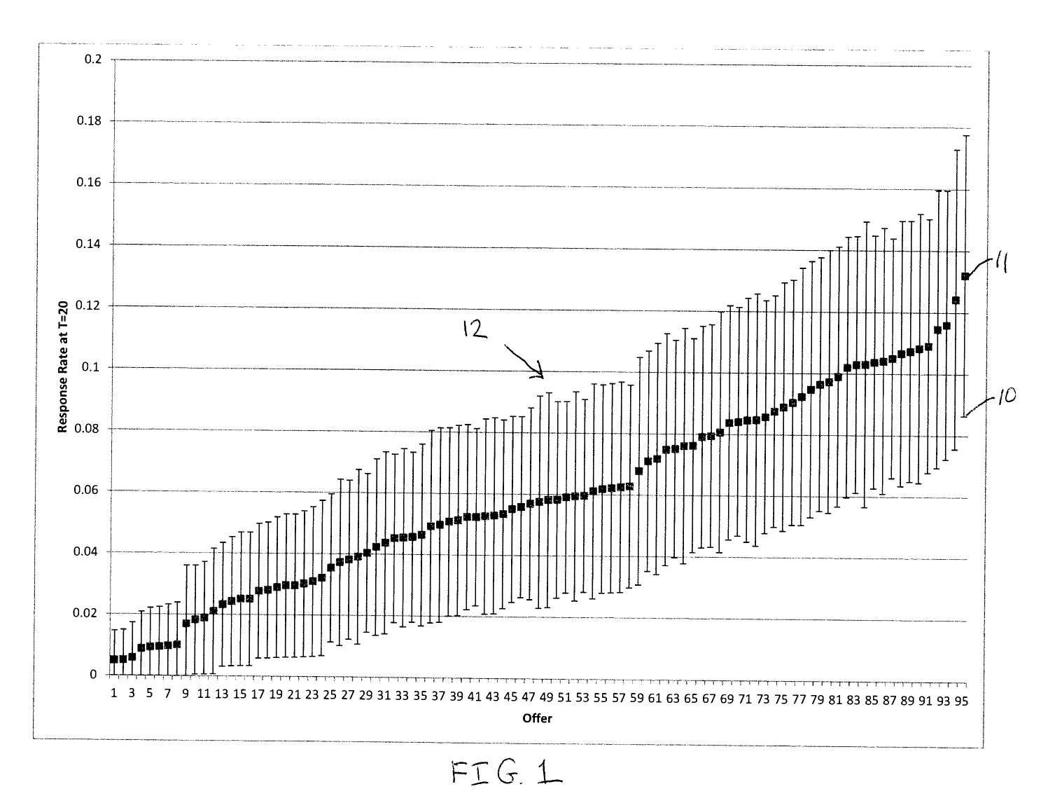

FIG. 1. illustrates such an application after simulating 20,000 displays of 100 offers (5 offers that received no clicks are removed from the figure for clarity.) The x-axis displays the offers in order of their click-through rate, and the y-axis shows that rate and 95% confidence interval for each offer. Notice the large overlap in the confidence interval from offer to offer, and how the low-end of the range 10 for the best offer 11 lies in the top end of the range for offers well into the middle part of the distribution 12. By comparing top offers to other offers individually, there is not a strong a basis for electing the S best offers yet.

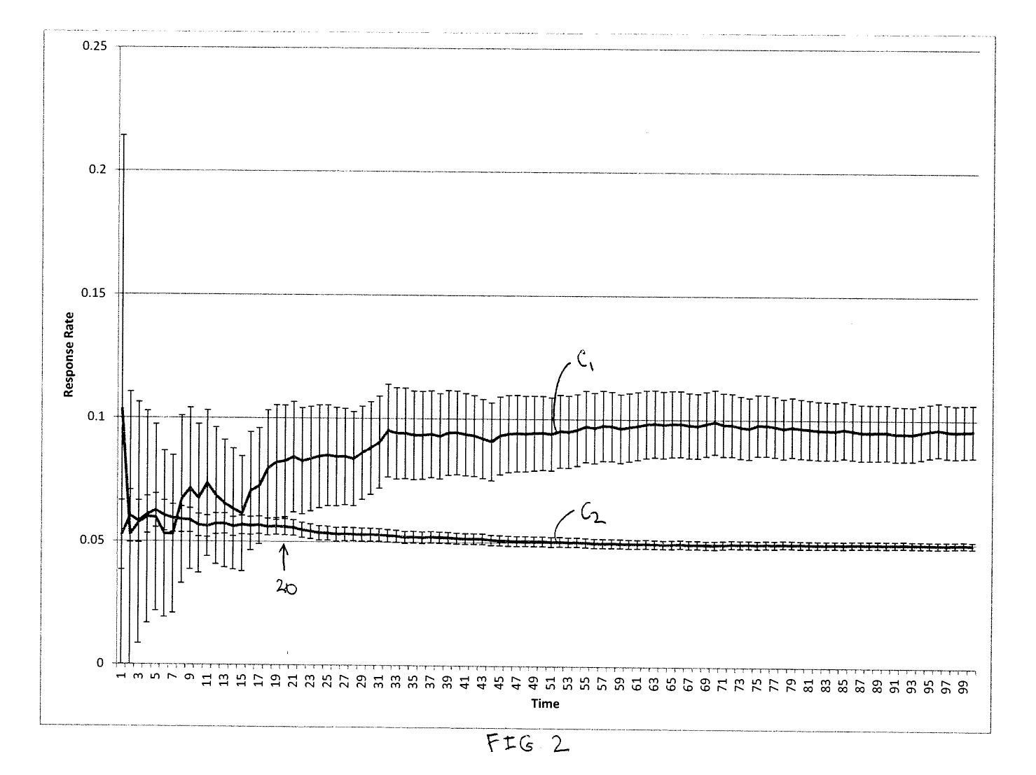

FIG. 2 illustrates an approach in which the processing circuit partitions the offers into two clusters C₁ and C₂, where given a pool of size n, C₁ is of size |S| and C₂ is of size n-|S|. C₁ comprises the |S| offers with the highest click-through rates; these are the offers the system will display once sufficient confidence is established. The x-axis shows “time”; each increment represents the display of 1,000 impressions. The y-axis shows the click-through rate and confidence interval for C₁ and C₂. The data from FIG. 1 is taken from one point in the time series, T=20. Notice at this time 20 in FIG. 2, the confidence intervals for C₁ and C₂ have completely diverged. Given this approach, at time T=20, the processing circuit has a strong basis for electing the S best offers.

As is shown, a group of offers can be regarded as a single offer in terms of summary statistics, and this allows the processing circuit to accumulate information faster. C₂ contains 97 offers; the confidence interval quickly narrows and stabilizes. In terms of our analogous problem, a cluster is a group of slot machines from which we select a machine at random, and pull a lever as if this was a single slot machine. We lose information about the differences among the slot machines in that group, but that information is unimportant in this problem. The information that is valuable is which slot machines have the highest payoff probability; the individual probabilities of the machines not in this set are less interesting.

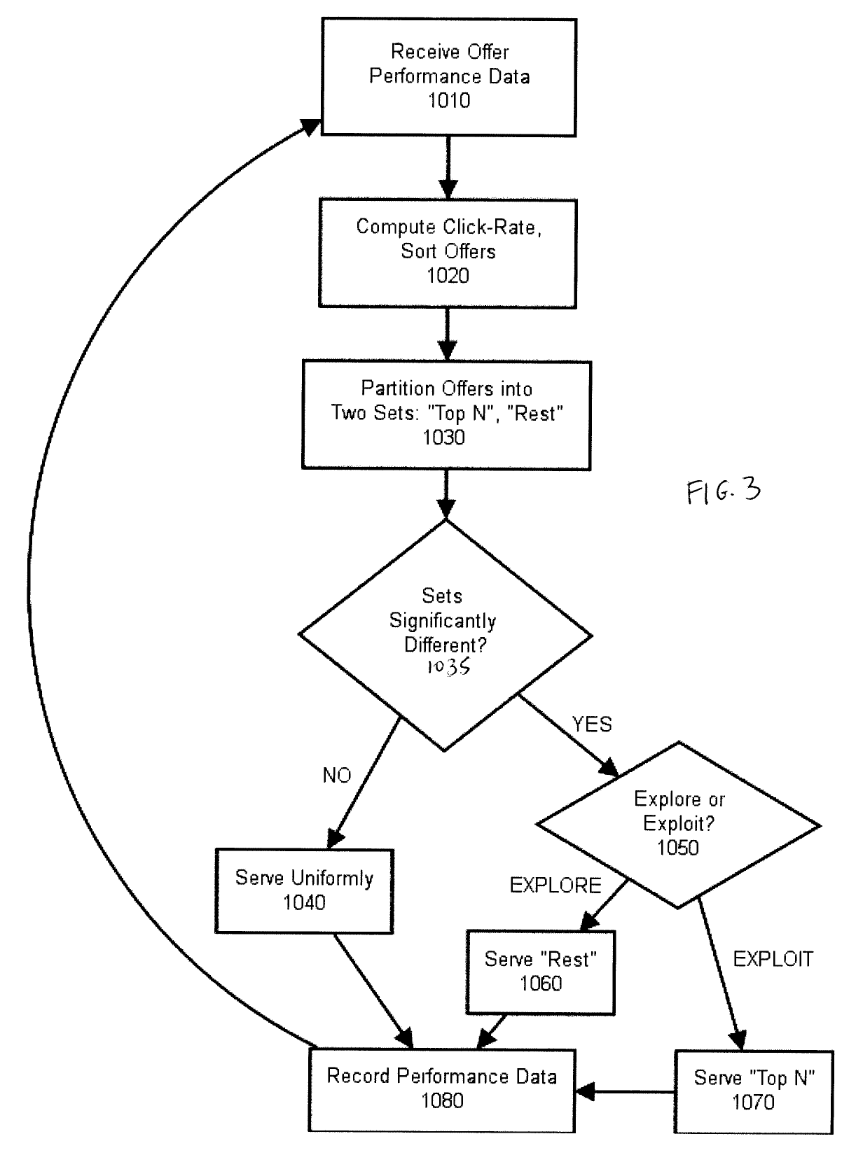

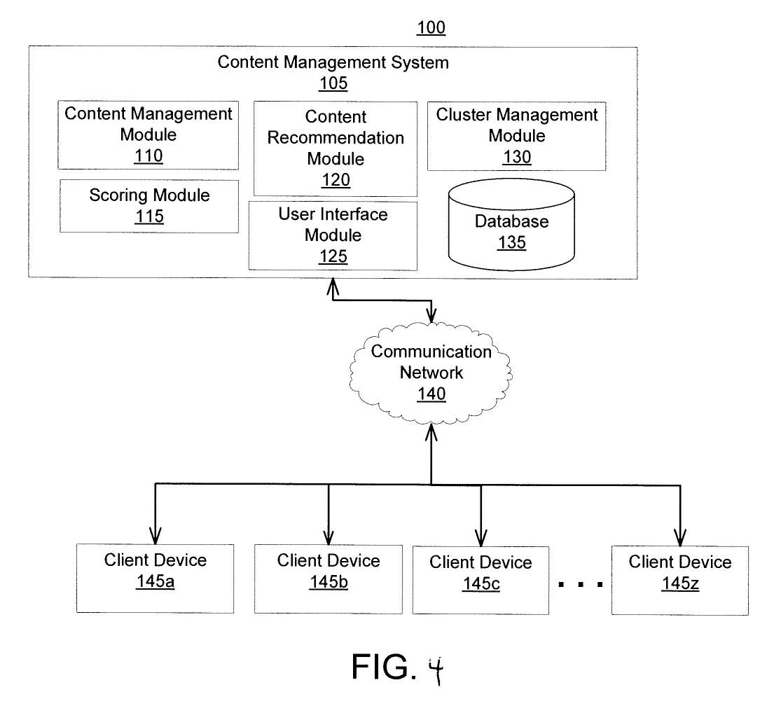

FIG. 3 is a flowchart illustrating a method, employed by the system according to one embodiment. FIGS. 4-6 are block diagrams illustrating embodiments of an exemplary system for operating the method.

FIG. 4 illustrates an exemplary system 100 for handling online content information, such as information associated with online offers (e.g., news articles, advertisements, white papers, product offerings, search results, etc.). Although the exemplary system 100 is discussed in greater detail below as handling information associated with online offers, for purposes of illustration, it should be appreciated that the concepts disclosed herein are not limited in this respect, and may apply more generally to various types of online content. For example, the online content may relate to any information displayed on web pages such as advertisements, promotions, articles, etc.

The exemplary system 100 includes a content management system 105, a communication network 140, and client devices 145a through 145z. The content management system 105 and the client devices 145a through 145z communicate via the communication network 140.

The content management system 105 is shown to include a content management module 110, a scoring module 115, a content recommendation module 120, a user interface module 125, a cluster management module 130, and a database 135. The modules and/or devices can be hardware and/or portions of circuitry programmed with software or code. The modules and/or devices illustrated in the content management system 105 can, for example, utilize a processor (e.g., processor 220) to execute computer executable instructions.

It should be understood that the content management system 105 can include, for example, other modules, devices, and/or processors known in the art and/or varieties of the illustrated modules, devices, and/or processors. It should be understood that the modules and/or devices illustrated in the content management system 105 can be located within the content management system 105 and/or connected to the content management system 105 (e.g., directly, indirectly, etc.), but outside of the physical components of the content management system 105 (e.g., server computer, shared, scalable computers such as a cloud computing environment, personal computer, mobile device, etc.).

The content management module 110 handles data associated with online content. For example, content data may include data for various offers such as offer description, offer text and graphics (e.g., a “creative”), as well as offer performance data such as number of impressions (i.e., number of times an offer has been shown to users on one or more web pages), number of clicks (i.e., number of times users have clicked on or selected the offer), number of conversions, etc. The content management module 110 stores such content data in the database 135.

In some embodiments, the content management module 110 (or alternatively the scoring module 115) may determine additional performance metrics for each offer such as click-through rate (i.e., number of clicks an offer has received divided by total number of impressions) based on historical data, expected click-through rate (e.g., using time-series regression), expected value or future expected value (e.g., revenue) of displaying an offer (e.g., using a utility function), etc. Due to the nature of online content publishing, offers may have short life cycles, and may be marked as inactive in the database 135 or removed from the database 135. New offers may be frequently (e.g., hourly, daily, etc.) added to the database 135 with little or no performance data accumulated. The database 135 may store online content data associated with one or more Internet web pages.

The scoring module 115 determines scores or weights for each offer maintained by the content management module 110. In some embodiments, the scores may be calculated only for offers that are active and may be displayed to users on the one or more web pages. The scores generated by the scoring module 115 may reflect popularity of the offers with online users in terms of numbers of impressions and numbers of clicks received. For example, an offer that has received a large number of impressions and a large number of online user clicks may have a higher score than an offer with a similar number of impressions but smaller number of online user clicks. As a result, over time, the content recommendation module 120 may select offers with higher scores more often than offers with lower scores for use in building a web page.

Using the click-through rates along with the number of impressions and clicks associated with an offer, the scoring module 115 may determine a confidence interval, for example using the method described hereinabove. The score for an offer determined by the scoring module 115 may correspond to, be proportional to, or otherwise be based on the click-through rate associated with the offer.

Some of the offers stored in the database 135 may have a low number of impressions and clicks. As a result, it may be difficult to discriminate between such offers and/or to optimize them. The confidence interval calculated by the scoring module 115 is utilized to determine whether offers can be discriminated and ranked. The scoring module 115 may order offers based on the calculated scores. Accordingly, offers with higher scores are ranked higher than offers with lower scores. In some embodiments, the cluster management module 130 may partition offers into two clusters—a “top N” offers cluster and a “rest” offers cluster. The “top N” offers cluster may include the top N offers from the set of available offers, and the “rest” offers cluster may include the rest of the offers.

The offers may be partitioned into two clusters using the offer click-through rates (e.g., N offers with highest click-through rates would be assigned to the “top N” offers cluster and the rest of the offers would be assigned to the “rest” offers cluster) or other values calculated for each offer. For example, other values calculated for each offer may include a predicted future click-through rate (e.g., as generated by a time-series regression), combination of a click-through rate with a value associated with an interaction (e.g., click might have varying monetary values with the expected value of displaying an offer being probability of a click multiplied by the value of the click), combination of an expected predicted future click rate with the expected value of displaying an offer, etc. The expected values may be normalized.

In other embodiments, the cluster management module 130 may partition offers into the two clusters using other values calculated for each offer. The cluster management module 130 may determine a transformation on the click-through rate for each offer, and assign N offers with the highest transformation values to the “top N” offers cluster and the rest of the offers to the “rest” offers cluster. For example, expected dollar value of putting an offer on a web site may be calculated for each offer and used to partition offers into the two clusters. The score may represent an expected utility of display given a context, where a context comprises a user, a site, and time. Thus, information about the user may influence the score, information about the page may influence the score, and information about when the event occurs may influence the score. The adjustments might be in the form of business rules, i.e., users from a certain U.S. state or company may not be eligible for an offer and so that offer would be weighted as zero. The adjustments might be in the form of simple rules, as the system should avoid making an offer a user has already accepted. The adjustments might be in the form of revenue; offer values may be variable. The adjustments may be predictive, i.e. certain classes of users may be more likely to click on certain offers. These examples are intended to be illustrative, and potential applications are not limited thereto.

In these embodiments, the cluster management module 130 may sample data from the two clusters and determine that the offers in the two clusters are significantly different at a given level of confidence. The cluster management module 130 would perform a significance test using the sample data to determine whether there is any significant difference between the two clusters. For example, the significance test used may be a binomial test for two proportions. The test statistic used depends upon the nature of the samples. Other tests that may be used include z-tests, t-tests, or non-parametric methods such as bootstrapping.

The content recommendation module 120 may receive a request to select a specific number of offers (e.g., 15 offers from available 1,500 offers stored in the database 135). The request may be received from the user interface module 125 or another module associated with the content management system 105. Alternatively, the request may be received from a third party system that displays or manages offers separately from the content management system 105.

In some embodiments, the content recommendation module 120 performs a weighted random selection without replacement of the requested number of offers from the available set of offers using the weights generated by the scoring module 115. Accordingly, offers with higher weights assigned to them are more likely to be drawn. If all offers had the same weight, every offer would have the same probability of being drawn for use in generating a web page.

In embodiments where the offers are partitioned into the “top N” offers cluster and the “rest” offers cluster, the content recommendation module 120 may draw offers from the two clusters based on a scheduling parameter (e.g., epsilon parameter). The scheduling parameter may be managed manually or dynamically. This parameter would specify percentage of the time that offers can be served from the two clusters. For example, the value of epsilon may be dynamically decreased as the certainty of the difference between the two offer clusters increases. Accordingly, more time is spent in exploitation of top offers, and less time in exploration of the rest of the offers. Offers from the “rest” offers cluster may be served epsilon percentage of the time, and offers from the “top N” offers cluster may be served (1-epsilon) percentage of the time. For example, the content management module 120 may draw offers from the “top N” offers cluster 80% of the time, and draw offers from the “rest” offers cluster 20% of the time (i.e., epsilon=0.20).

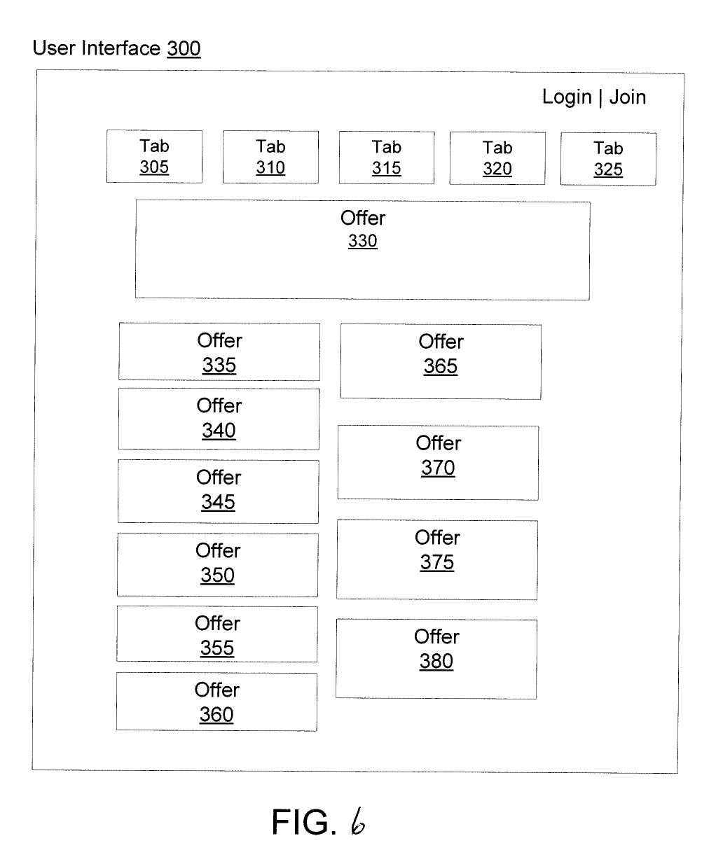

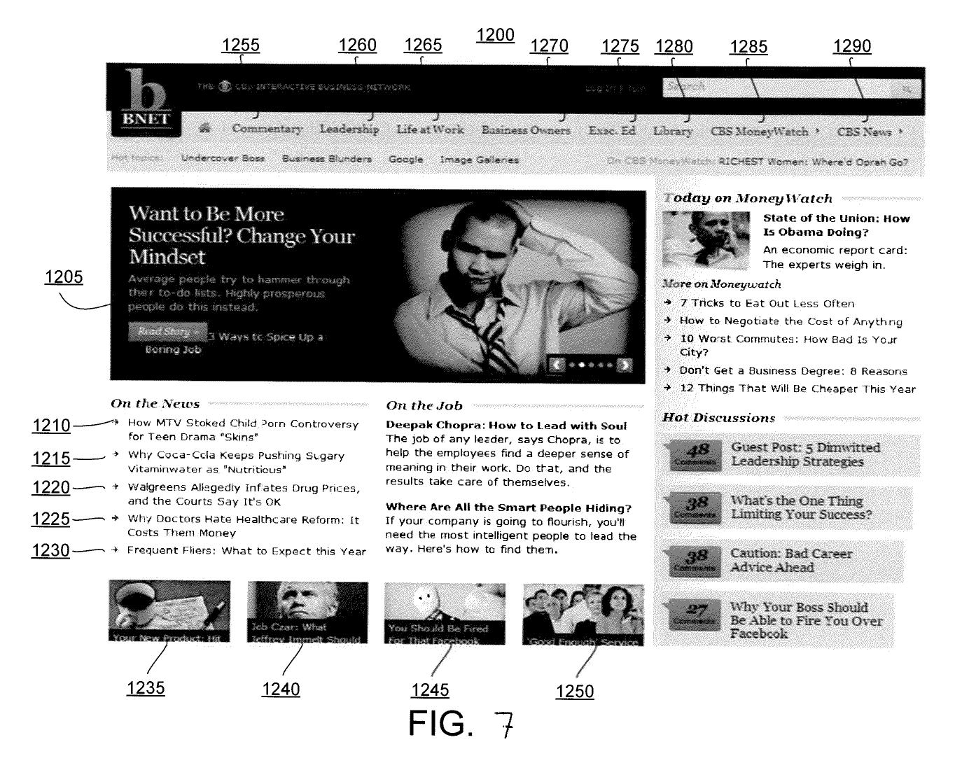

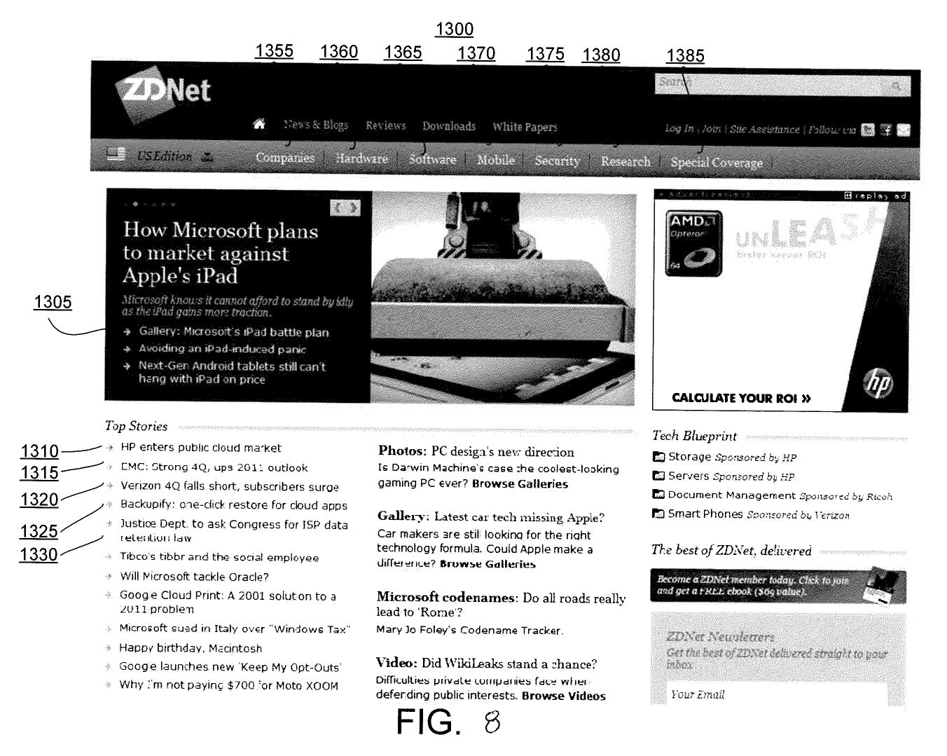

The user interface module 125 manages one or more user interfaces available to online users. For example, user interfaces may include one or more web pages that display offers to online users. FIG. 6 illustrates a block diagram of an exemplary user interface, while FIGS. 7-8 show two exemplary web pages displaying multiple online offers.

FIGS. 7 and 8 illustrate screen shots of interfaces displaying exemplary user interfaces 1200 and 1300. FIG. 7 illustrates a user interface 1200 displaying various offers including offers 1205 through 1250. The user interface 1200 is an exemplary web page providing business professionals and entrepreneurs with business commentary, advice, insights and other web content. In some embodiments, the user interface 1200 is a dynamic web page that may display different content every time the web page is loaded into the browser and/or a user clicks on one of the links or buttons on the web page. For example, when a user clicks on one of the available tabs 1255 through 1290, a different web page may be displayed to the user with content related to the selected tab. Any of the offers 1205-1250 may be periodically removed and replaced with other offers that are more current or are more likely to yield user clicks.

Online users may join the web site associated with the user interface by supplying personal information including geographic location, content preferences, news topics of interest, etc. Based on the user's preferences, the user interface 300 may display content that is of particular interest to the user. Accordingly, the user is at least partially in control of the information he/she views. In some embodiments, registered users periodically receive electronic newsletters that may be catered to the user's interests and preferences. Accordingly, the content of these electronic newsletters may be different for different users. The electronic newsletters may contain offers as determined by the content recommendation module 120 using scores assigned to available offers.

As illustrated, offer 1205 is allocated more space on the user interface 1200 than other offers. For example, the content recommendation module 120 may have determined that offer 1205 ought to be one of the primary offers displayed in the user interface 1200 because it was assigned a higher score indicating that it is more likely to receive a higher number of user clicks than other offers. Clicking on the offer 1205 would cause the user interface 1200 to display the entire story to the user.

FIG. 8 illustrates a user interface 1300 displaying various technology related offers including articles and other resources. For example, offers 1305-1330 are articles covering latest technology news. In some embodiments, the content recommendation module 120 determines offers from a plurality of available offers using scores assigned to each available offer. As a result, the user interface 1300 displays offers that are most likely to receive clicks from online users. Tabs 1355-1385 allow users to view offers related to specific topics such as companies, hardware, software, mobile, security, etc.

As discussed in relation to FIGS. 1-2, offers may be grouped into clusters and assigned combined scores. The user interface 1300 may display one or more offers assigned to clusters in order to collect additional impressions and user clicks information for these offers. For example, offer 1330 may be part of a cluster, and will receive additional impressions and user clicks by being displayed on the user interface 1300. Offers may be partitioned into two clusters (i.e., “top N” offers cluster and “rest” offers cluster). The user interface 1300 may display offers from the two clusters based on calculations of confidence level and epsilon values discussed above.

Returning to FIG. 4, although a single communication network 140 is illustrated, the system can include a plurality of communication networks and/or the plurality of communication networks can be configured in a plurality of ways (e.g., a plurality of interconnected local area networks (LAN), a plurality of interconnected wide area networks (WAN), a plurality of interconnected LANs and/or WANs, etc.).

Although FIG. 4 illustrates the content management system 105 and the client devices 145a through 145z, the system 100 can include any number of content management systems, and/or client devices. Other third party systems may display offers managed by the content management system 105 to the online users.

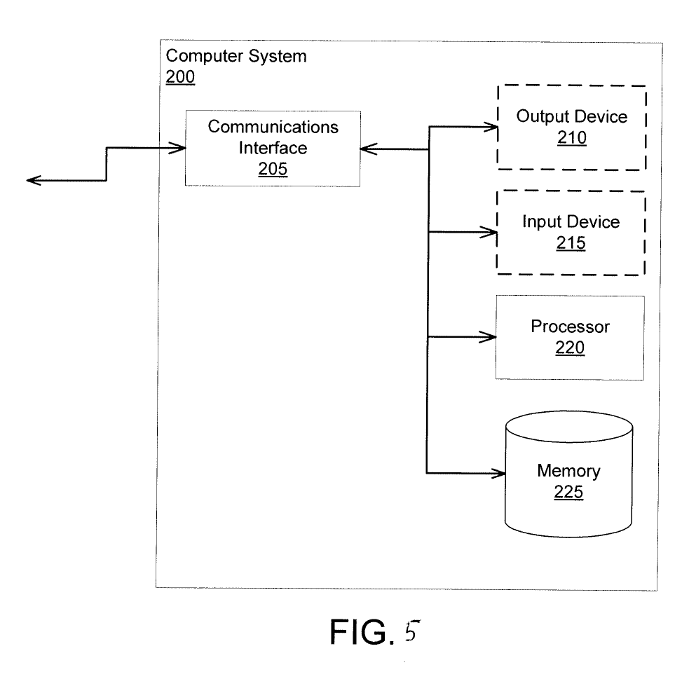

FIG. 5 shows the general architecture of an illustrative computer system 200 that may be employed to implement any of the computer systems discussed herein (including content management system 105 and client devices 145a through 145z) in accordance with some embodiments. The computer system 200 of FIG. 5 comprises one or more processors 220 communicatively coupled to memory 225, one or more communications interfaces 206, and optionally one or more output devices 210 (e.g., one or more display units) and one or more input devices 215.

In the computer system 200 of FIG. 5, the memory 225 may comprise any computer-readable storage media, and may store computer instructions (also referred to herein as “processor-executable instructions”) for implementing the various functionalities described herein for respective systems, as well as any data relating thereto, generated thereby, and/or received via the communications interface(s) or input device(s) (if present). Referring again to the system 100 of FIG. 4, examples of the memory 225 include the database 135 of the content management system 105. The processor(s) 220 shown in FIG. 5 may be used to execute instructions stored in the memory 225 and, in so doing, also may read from or write to the memory various information processed and or generated pursuant to execution of the instructions.

The processor 220 of the computer system 200 shown in FIG. 5 also may be communicatively coupled to and/or control the communications interface(s) 205 to transmit and/or receive various information pursuant to execution of instructions. In particular, the communications interface(s) 205 may be coupled to a wired or wireless network, bus, or other communication means and may therefore allow the computer system 200 to transmit information to and/or receive information from other devices (e.g., other computer systems). While not shown explicitly in the system of FIG. 4, one or more communications interfaces facilitate information flow between various elements/sub-systems of the content management system 105. In some implementations, the communications interface(s) may be configured (e.g., via various hardware components and/or software components) to provide a website as an access portal to at least some aspects of the computer system 200. Examples of communications interfaces 205 include user interfaces (e.g., web pages) accessed by users to view online offers.

The optional output devices 210 of the computer system 200 shown in FIG. 5 may be provided, for example, to allow various information to be viewed or otherwise perceived in connection with execution of the instructions. The optional input device(s) 215 may be provided, for example, to allow a user to make manual adjustments, make selections, enter data or various other information, and/or interact in any of a variety of manners with the processor during execution of the instructions. Additional information relating to a general computer system architecture that may be employed for various systems discussed herein is provided at the conclusion of this disclosure.

FIG. 6 illustrates a user interface 300, according to an exemplary embodiment. FIG. 6 is shown to include tabs 305 through 325 as well as offers 330 through 380. Although only eleven offers are displayed to online users in the user interface 300, a set of available offers may contain a larger number of offers (e.g., 10,000 offers). In one embodiment, the offers may be selected from the two clusters (i.e., the “top N” offers cluster and the “rest” offers cluster) created by the cluster management module 130.

In some embodiments, one of the offers selected for display on the user interface is randomly selected to receive more space on the user interface. The offer 330 may be periodically substituted with one or more other offers. Similarly, offers 335 through 380 may be replaced with other offers that may be more current or have received higher scores.

When a user successfully logs into the user interface using user authenticating information (e.g., user name and/or password), more offers may be displayed to the user. A user selecting one of the available tabs 305 through 325 may cause the user interface 300 to display a different set of offers that are related to the selected tab. The user interface 300 may display to the user any number of offers or other online content including links, advertisements, etc. Offers may also be provided in the form of overlays, pop-ups, banners, etc.

Returning to FIG. 3, a flowchart illustrates a method which may be employed by the content management system 100 of FIG. 1. In block 1010 of FIG. 6, the content management module 110 of the content management system 105 receives data associated with a plurality of offers. Data for each offer may include unique offer identifier, offer description, offer graphics, number of impressions received, number of clicks or other interactions received, etc.

Based on the offer data, in block 1020, the scoring module 115 determines a click-through rate (“CTR”) and a confidence interval for each offer. In some embodiments, the CTR for an offer is calculated by dividing the number of users who have clicked on or otherwise interacted with (e.g., a mouse-over, etc.) the offer by the number of impressions (i.e., the total number of times the offer was displayed) received by the offer. For example, if an offer (e.g., an advertisement) was displayed 1,000 times and 10 users clicked on it, then the resulting CTR would be 1%. The CTR indicates the success of an offer with more successful offers having higher CTR.

The confidence interval indicates a point estimate for the CTR. For offers that have not received a significant number of impressions, the confidence interval may have a wider range. For example, an offer that has received one thousand impressions and ten clicks has a 1% CTR, as well as an offer with ten million impressions and hundred thousand clicks also has a 1% CTR. Although both offers have the same CTR, the offer with one thousand impressions will have a wide confidence interval, while the offer with ten million impressions will have a narrower confidence interval. Accordingly, the more observations an offer receives, the narrower the confidence interval would be. The confidence interval equation described hereinabove may be used at this block to calculate a confidence interval for each offer.

In block 1030, the system partitions offers into two sets or clusters. The cluster management module 130 partitions offers into two clusters—a “top N” offers cluster and a “rest” offers cluster. The “top N” offers cluster includes N number of best offers as determined by the cluster management module 130. In some embodiments, N (e.g., 3, 5, 10, etc.) may be a number of offers that a web site requested for display. In other embodiments, N may be set programmatically or manually by a user. The “rest” offers cluster includes the rest of the offers. For example, if N number of offers is 3 and the total number of available offers is 20, then the “top N” offers cluster would include 3 offers, while the “rest” offers cluster would include 17 offers.

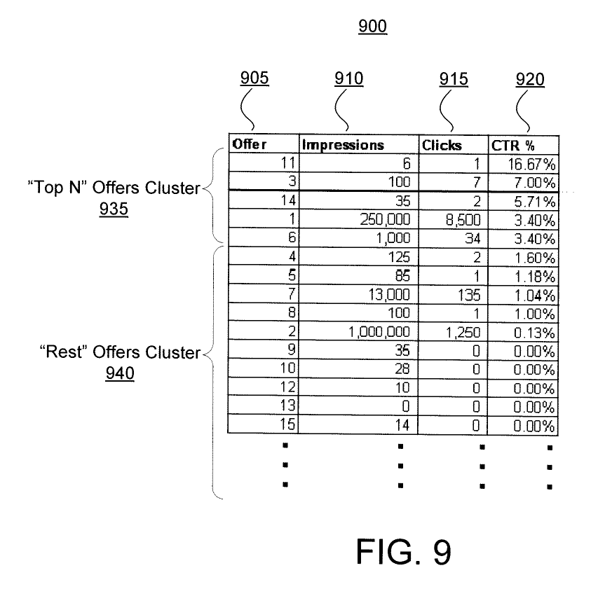

In some embodiments, the cluster management module 130 partitions offers into the two clusters using the CTR rates associated with the offers. In these embodiments, the N offers with highest click-through rates would get assigned to the “top N” offers cluster, while the rest of the offers would get assigned to the “rest” offers cluster. For example, as illustrated in FIG. 9, five offers (i.e., N equals five in this example) with the highest click-through rates are assigned to the “top N” offers cluster 935, and the rest of the offers are assigned to the “rest” offers cluster 940.

FIG. 9 illustrates an exemplary table 900 containing performance data associated with offers sorted by CTR, according to an exemplary embodiment. The table 900 is shown to include offer identification (e.g., offer ID) 905, number of impressions 910, number of clicks 915, and CTR 920. Although the table 900 is shown to include fifteen offers, it may store data for any number of offers associated with any number of web sites. The exemplary table 900 may be stored in the database 135 of the content management system 105.

As illustrated, the fifteen offers shown in table 900 are sorted by the CTR column, in descending order. The fifteen offers are partitioned into two clusters: a “top N” offers cluster 935, and a “rest” offers cluster 940. The top five offers (i.e., offers 11, 3, 14 1, and 6) with highest click-through rates are assigned to the “top N” offers cluster 935, while the rest of the offers are assigned to the “rest” offers cluster 940. In other embodiments, the “top N” offers cluster 935 may be assigned offers based on other values assigned to each offer. For example, each offer may be assigned an expected dollar value to the operator of the web page on which the offer is to be displayed. In this example, the offers with highest expected dollar values would be assigned to the “top N” offers cluster 935, and the rest of the offers would be assigned to the “rest” offers cluster 940.

When offers are displayed to users on a web site, additional performance data including number of clicks and impressions is collected. Using the additional offer data, the click-through rates 920 and other offer attributes may be periodically (e.g., hourly, daily, weekly, when a predetermined number of new impressions and/or clicks is received, etc.) re-calculated by the content management module 110 using additional offer data (e.g., number of impressions and clicks).

Referring again to FIG. 3, at block 1035 the system is configured to determine if the two set are significantly different. The system may determine if the performance data of the offers in the first set (e.g., averaged or otherwise combined) is greater than a predetermined threshold away from the performance data of the offers in the second set. If not, the system serves all adds from both sets uniformly (block 1040), additional performance data is recorded (block 1080) and the process returns to block 1010.

In block 1035, the cluster management module 130 samples offers from the two clusters. The sampling technique may involve determining a possible offer representation from the underlying cluster, where an offer is selected at random from the underlying offer set. An event from data recorded for that offer is then chosen at random, with the event of displaying that offer yielding either a click or no click.

In one embodiment, given a predetermined number of impressions (e.g., manually entered by user, determined programmatically, etc.), a number of clicks is determined by sampling without replacement from recorded observations in the underlying set of offers belonging to one of the clusters. For example, if the number of impressions is set to 1,000, then 1,000 offers are randomly selected from the cluster, and for each selected offer, an event from recorded data for that offer is chosen at random, where the event of displaying that offer yields either a click or no click. An offer representing the underlying cluster may be created using the predetermined number of impressions and the number of clicks determined based on randomly sampling offers and events.

Using the sample data, the cluster management module 130 uses a statistical test to determine whether there is a significant difference between the “top N” offers cluster and the “rest” offers cluster. The confidence level would indicate a degree of certainty that the offers in the “top N” offers cluster are better than the offers in the “rest” offers cluster. The significance test may be performed using a null hypothesis. For example, the null hypothesis may state that the click-through rate (or another value associated with the offers) of the “top N” offers group is the same as the click-through rate of the “rest” offers group, or that it is not significantly different. An alternative hypothesis may state that the click-through rate of the “top N” offers cluster is significantly higher than the click-through rate of the “rest” offers cluster.

In one embodiment, the statistical testing applied to the two clusters may utilize a binomial test for two proportions, with a one-tailed test. The confidence level may be the probability for a one tailed-test given the results of the binomial test. For example, the confidence level may be 95%, which would indicate that there is a significant difference between the offers in the two clusters.

In blocks 1040, 1050 and 1060, the content recommendation module 120 may serve offers to a web site. In some embodiments, if the difference between the “top N” offers cluster and the “rest” offers cluster is found to be significant, the content recommendation module 120 may determine to serve offers from the “top N” offers cluster more often than the offers from the “rest” offers cluster. If the finding of the significance test indicates that there is a significant difference between the two sets of offers, then the offers from the “rest” offers cluster may be served (block 1120) uniformly epsilon percentage of the time, and the offers from the “top N” offers cluster are served (block 1125) (1-epsilon) percentage of the time. While over time individual offers may converge on a predictable rate, clustering offers into two clusters as discussed above advantageously determines the overall average convergence faster.

In some embodiments, the epsilon is managed programmatically by dynamically computing it based on ongoing certainty. For example, the amount of traffic needed to maintain a certain decision (e.g., that offers in the “top N” offers cluster are better than the offers in the “rest” offers cluster) may be analyzed in order to compute the epsilon dynamically. In other embodiments, the epsilon is managed manually by a user. For example, based on the historical data, it is determined that the confidence level of the top N offers in the “top N” offers cluster being better than the offers in the “rest” offers cluster is 99%. However, there may not be enough data to support the hypothesis on an ongoing basis if only offers from the “top N” offers cluster are served the rest of the time. Accordingly, it may be beneficial to still serve offers from the “rest” offers cluster in order to maintain a desired confidence level between the two clusters. For example, with a 99% confidence level, it may be determined that offers from the “top N” offers cluster are to be served 80% of the time (i.e., epsilon=0.20), and offers from the “rest” offers cluster are to be served 20% of the time. Accordingly, epsilon determines what percentage of the time to serve offers from each of the two clusters and still maintain a desired level of confidence (e.g., 99% confidence level).

If the sets are significantly different, processing may continue to block 1050 which determines whether to explore or exploit further. The decision may be made alternately (e.g., explore followed by exploit followed by explore, etc.), based on day, date or time, or based on other factors such as the type of content the offer relates to. If the decision is made to explore, at block 1060 the offers in the “rest” set are served and performance data is recorded (block 1080). If the decision is made to exploit, at block 1070 the Top N offers are served and performance data is recorded (block 1070).

According to some embodiments, the system can monitor the cluster click-through rates until the cluster confidence intervals become disjoint, at which time the system can begin serving the |S| best offers a majority of the time.

According to some embodiments, the system can perform a formal significance test on the two clusters and determine at some level of confidence that the mean click-through rates of the group are different, for example, a binomial test for two proportions or a t-test.

According to some embodiments, the system can use alternative methods for deriving a more precise value for predicted click-through rates, for example, a time series regression on each individual offer or on offer clusters, or a temporal discounting of historical actions (“decay”), etc.

According to some embodiments, the system can assign a value or weight to an offer click, and compute ranges of expected values (based on historical performance) or predicted future values (based on predicted values) rather than click probabilities.

According to some embodiments, the system may reset when new offers are introduced, in order to both fairly compare the rates for the new offers to the older offers, and to hedge against non-stationarity in the click probability distributions.

According to some embodiments, the system may adjust the confidence interval, adjusting for risk-averse or risk-seeking behavior according to application requirements.

According to some embodiments, the system may represent a cluster using offer models to compensate for varying numbers of impressions (e.g., a mix of new and old offers), and sample from the models or use bootstrapping for estimation rather than using historical data directly to estimate click-through rates.

According to some embodiments, the system may purge individual offers that show a likelihood of a click below some threshold in order to make more efficient use of the opportunity to display offers.

According to some embodiments, using the clusters, the system may adopt any of the standard bandit strategies, e.g., epsilon-greedy, -first, or -decreasing, or probability matching.

According to some embodiments, the system may establish different clusters for different contexts, e.g., week vs. weekend or domestic vs. international visitor.

According to some embodiments, the system may accumulate and score data on an interval of e.g., one day, hours, or in real-time. According to some embodiments, offers are partitioned into the Top N offers and the rest of the offers. In alternate embodiments, offers may be selected individually.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein.

The above-described embodiments can be implemented using hardware, software or a combination thereof. When implemented in software, the software code can be executed on any suitable processor or collection of processors, whether provided in a single computer system (“computer”) or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

The various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

Additionally, it should be appreciated that according to one aspect, one or more computer programs that when executed perform methods of the present invention need not reside on a single computer or processor, but may be distributed in a modular fashion amongst a number of different computers or processors to implement various aspects of the present invention.

The indefinite articles “a” and “an,” as used herein in the specification and in the claims, unless clearly indicated to the contrary, should be understood to mean “at least one.”

What is claimed is:

1. In a system comprising at least one processor, at least one memory, and at least one communications interface, a computer-implemented method for serving offers, the method comprising:
receiving data for a plurality of offers, wherein the data includes a number of impressions and a number of clicks associated with each offer in the plurality of offers;
determining a click-through rate for each offer in the plurality of offers using the received data for the plurality of offers;
partitioning offers into a first offer group and a second offer group based on a value of performance data associated with each offer, with a predetermined number of offers with highest values being assigned to the first offer group, and the rest of the offers assigned to the second offer group;
serving offers from both groups;
calculating a response rate and confidence level for the first group;
calculating a response rate and confidence level for the second group;
determining that the performance data of the first and second groups has diverged by a predetermined threshold; and
serving the offers based at least in part on the determining.

2. The method of claim 1, further comprising storing the determined click-through rates and confidence levels in a database.

3. The method of claim 1, wherein the confidence level is calculated using is a binomial proportion test.

4. The method of claim 1, wherein the performance data is the click-through rate calculated for each offer based on historical offer data.

5. The method of claim 1, further comprising:
transmitting display data representing the selected offers to a user interface.

6. The method of claim 5, wherein the transmitted display data is formatted to generate a webpage at the user interface.

7. The method of claim 1, wherein the number of clicks associated with each offer is a combined number of clicks the offer received on a user interface from one or more users.

8. The method of claim 1, wherein the number of impressions associated with each offer is a combined number of times each offer was displayed to one or more users on a user interface.

9. At least one non-transitory computer readable storage medium encoded with processor-executable instructions that, when executed by at least one processor, perform a method, the method comprising:
receiving data for a plurality of offers, wherein the data includes a number of impressions and a number of clicks associated with each offer in the plurality of offers;
determining a click-through rate for each offer in the plurality of offers using the received data for the plurality of offers;
partitioning offers into a first offer group and a secoregrend offer group based on a value of performance data associated with each offer, with a predetermined number of offers with highest values being assigned to the first offer group, and the rest of the offers assigned to the second offer group;
serving offers from both groups;
calculating a response rate and confidence level for the first group;
calculating a response rate and confidence level for the second group;
determining that the performance data of the first and second groups has diverged by a predetermined threshold; and
serving the offers based at least in part on the determining.

10. The method of claim 9, further comprising storing the determined click-through rates and confidence levels in a database.

11. The method of claim 9, wherein the confidence level is calculated using is a binomial proportion test.

12. The method of claim 9, wherein the performance data is the click-through rate calculated for each offer based on historical offer data.

13. The method of claim 9, further comprising:
transmitting display data representing the selected offers to a user interface.

14. The method of claim 13, wherein the transmitted display data is formatted to generate a webpage at the user interface.

15. The method of claim 9, wherein the number of clicks associated with each offer is a combined number of clicks the offer received on a user interface from one or more users.

16. The method of claim 9, wherein the number of impressions associated with each offer is a combined number of times each offer was displayed to one or more users on a user interface.

17. An apparatus for generating scores for offers relating to maximizing user clicks, the apparatus comprising:
at least one communications interface;
at least one memory to store processor-executable instructions; and
at least one processor communicatively coupled to the at least one communications interface and the at least one memory, wherein upon execution of the processor-executable instructions, the at least one processor:
receive data for a plurality of offers, wherein the data includes a number of impressions and a number of clicks associated with each offer in the plurality of offers;
determine a click-through rate for each offer in the plurality of offers using the received data for the plurality of offers;
partition offers into a first offer group and a second offer group based on a value of performance data associated with each offer, with a predetermined number of offers with highest values being assigned to the first offer group, and the rest of the offers assigned to the second offer group;
serve offers from both groups;
calculate a response rate and confidence level for the first group;
calculate a response rate and confidence level for the second group;
determine that the performance data of the first and second groups has diverged by a predetermined threshold; and
serve the offers based at least in part on the determining.

18. The method of claim 17, further comprising storing the determined click-through rates and confidence levels in a database.

19. The method of claim 17, wherein the confidence level is calculated using is a binomial proportion test.

20. The method of claim 17, wherein the performance data is the click-through rate calculated for each offer based on historical offer data.
